(19) United States
(12) Patent Application Publication
(10) Pub. No.: US 2007/0201824 A1
(43) Pub. Date: Aug. 30, 2007

(54) TV broadcast viewing and recording system

(75) Inventors: Yasuo Masaki, Osaka (JP); Hirono Tsubota, Osaka (JP); Akinori Okazaki, Osaka (JP); Sadanori Murakami, Osaka (JP); Yukiyoshi Sasao, Osaka (JP); Masahiro Takeshita, Osaka (JP); Masao Kokado, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/702,511

(22) Filed: Feb. 6, 2007

(30) Foreign Application Priority Data
Feb. 7, 2006 (JP) 2006-029829

(51) Int. Cl. H04N 5/91

(52) U.S. Cl. 386/83

(57) ABSTRACT

A TV broadcast viewing and recording system, which can enhance viewing efficiency for each user to view TV programs even though several users use the system. The TV broadcast viewing and recording system (1) comprises a TV receiver (2), a recorder (3), and a camera (4) which takes an image in a predetermined imaging area in front of the TV receiver (2) or the recorder (3). When the user surfs the channels (S51), the TV receiver (2) transmits a request signal to the recorder (3) (S52). The recorder (3) performs facial recognition of an image data taken by the camera (4), identifies the user by calculating a feature quantity of the user who changes the channels (S53), and extracts data files of TV programs which has not been reproduced yet (S54). Subsequently, the recorder (3) transmits a message signal including information of un-reproduced data files of TV programs to the TV receiver (2) (S55). The TV receiver (2) displays a list of the un-reproduced data files of TV programs on the basis of the received information so that the user can confirm existence of TV programs which has not been reproduced yet(S56).

### BACKGROUND OF THE INVENTION

1. Field of the Invention

The present invention relates to a television (TV) broadcast viewing and recording system comprised of a TV receiver and a recorder so as to display images of a TV program on a monitor screen of the TV receiver with using TV broadcast signals directly received or recorded in the recorder.

2. Description of the Related Art

Conventionally, a TV broadcast viewing and recording system is comprised of a TV receiver, that receives TV broadcast signals and displays images of a TV program on a monitor screen thereof so that a user can view the TV program, and a recorder such as a DVD recorder, that is connected to the display apparatus, records data of a TV program, reproduces recorded data of a TV program and outputs the reproduced data to the TV receiver so that the user can watch the recorded TV program. In order to enhance viewing efficiency, it is proposed to encourage a user or users to view the recorded TV programs which are not viewed yet.

A conventional digital data recorder, for example, disclosed in Japanese Laid-Open Patent Publication No. 2002-100158 notifies that a data file which is recorded but nor reproduced exists to a user after passing a predetermined time period from the recording of the data file or at a time of switching on of a power switch. This apparatus outputs a data for a message image to notify the fact to the user to a display apparatus.

Similarly, Japanese Laid-Open Patent Publication No. 2002-185904 discloses a method to display information of a TV program which is recorded in a recorder when electric power of a display apparatus is switched on.

Japanese Laid-Open Patent Publication No. 2002-218369 discloses an apparatus that displays a message on a TV receiver when a TV program or TV programs not reproduced yet exists or exist in one of a plurality of recorders connected to the TV receiver through a network.

As described above, it is possible to prevent that TV programs which are recorded in the recorder are forgotten by a user or users, or waste memory of the recorder by notifying the TV programs that are not reproduced yet.

When the TV broadcast viewing and recording system is used by a plurality of user, it is necessary to manage the information whether the recorded TV programs has been reproduced or not per each user in order to notify the recorded TV programs which are not reproduced yet to the users. Japanese Laid-Open Patent Publication No. 2004-199741 discloses a recorder that can manage the information whether each TV program has been reproduced or not per each user for a plurality of users. When a user who uses the recorder is selected, the recorder outputs the information of the TV programs which are not reproduced yet for the identified user. This recorder, however, needs an operation to select the user, so that the information of the TV programs not reproduced yet are not notified unless the user intends to do so.

Japanese Laid-Open Patent Publication No. 2005-117185 discloses a digital TV receiver that performs facial recognition with taking an image of a user, and then performs automatic functional restriction depending on the user recognized by the apparatus. This apparatus, however, cannot manage the information of the recorded TV programs in a recorder.

Japanese Laid-Open Patent Publication No. 2005-109982 discloses a TV broadcast viewing and recording system that displays a list of TV programs recorded in a hard disk drive on a TV receiver when in case that a user frequently switches the channels so as to encourage the user to reproduce the recorded TV programs. This apparatus, however, cannot manage the information whether each recorded TV program has been reproduced or not, and cannot identify the user who uses the apparatus.

### SUMMARY OF THE INVENTION

The present invention is perceived to solve the problems of the conventional arts described above, and an object of the present invention is to provide a TV broadcast viewing and recording system which can enhance viewing efficiency of TV programs recorded in a recorder for each user by automatically identifying the user who uses the system even when the system is used by a plurality of users, and thus the system can be used more conveniently.

A TV broadcast viewing and recording system in accordance with an aspect of the present invention comprises:

a TV receiver which receives TV broadcast signals and displays a TV program of a channel specified by an operation of a user so that the user can view the TV program;

a recorder which is connected to the TV receiver and which has a recording function to receive TV broadcast signals and to store a data file of TV program in response to an operations of a user and a reproduction function to reproduce the recorded data file of TV program as video signals and audio signals and then transmits the reproduced video signals and audio signals to the TV receiver so that a user can view a recorded TV program; and

an image pickup device which is provided to communicate with the recorder or the TV receiver and takes an image in a predetermined area in front of the TV receiver, wherein the TV receiver and the recorder are connected to each other to enable data communication;

the recorder manages a reproduction history of data files of TV programs for each user by performing facial recognition based on an image data taken by the image pickup device, and identifies a user by calculating a feature quantity of the user based on the image data taken by the image pickup device;

when the TV receiver is operated a predetermined operation by a user, the TV receiver transmits a predetermined request signal to the recorder in response to the operation by the user;

when the recorder receives the request signal, the recorder identifies the user who operates the TV receiver by performing facial recognition based on an image data taken by the image pickup device, and the recorder transmits a predetermined massage signal showing existence of un-reproduced one or more data files of TV programs which are recorded by the identified user in case that the un-reproduced data files of TV programs exist; and

the TV receiver displays information relating to the un-reproduced data files of TV programs based on the message signal on a display thereof.

According to the above mentioned configuration, it is possible to display the information relating to the un-reproduced data files of TV programs, so that the user can confirm the existence of the TV programs which has not been reproduced yet in the recorder. Furthermore, the user who stays in the imaging area can be identified, so that only the data files of TV programs relating to the identified user can be extracted among all the data files of TV programs. Thus, viewing efficiency for the identified user to view TV programs recorded in the recorder can be enhanced.

While the novel features of the present invention are set forth in the appended claims, the present invention will be better understood from the following detailed description taken in conjunction with the drawings.

### BRIEF DESCRIPTION OF THE DRAWINGS

The present invention will be described below with reference to the annexed drawings. It is to be noted that all the drawings are shown for the purpose of illustrating the technical concept of the present invention or embodiments thereof, wherein:

FIG. 1 is a block diagram illustrating a configuration of a TV broadcast viewing and recording system in accordance with a preferred embodiment of the present invention;

FIG. 2A is a flow chart showing a normal recording operation of a recorder constituting the TV broadcast viewing and recording system of FIG. 1;

FIG. 2B is a flowchart showing a programmed recording operation of the recorder of FIG. 2A;

FIG. 3A is a flowchart showing an operation to encourage a user to reproduce data files of TV programs which are not reproduced yet when electric power of a TV receiver constituting the TV broadcast viewing and recording system of FIG. 1 is switched on; and

FIG. 3B is a flowchart showing an operation to encourage the user to reproduce data files of TV programs which are not reproduced yet when the user frequently switches the channels.

### DESCRIPTION OF THE PREFERRED EMBODIMENTS

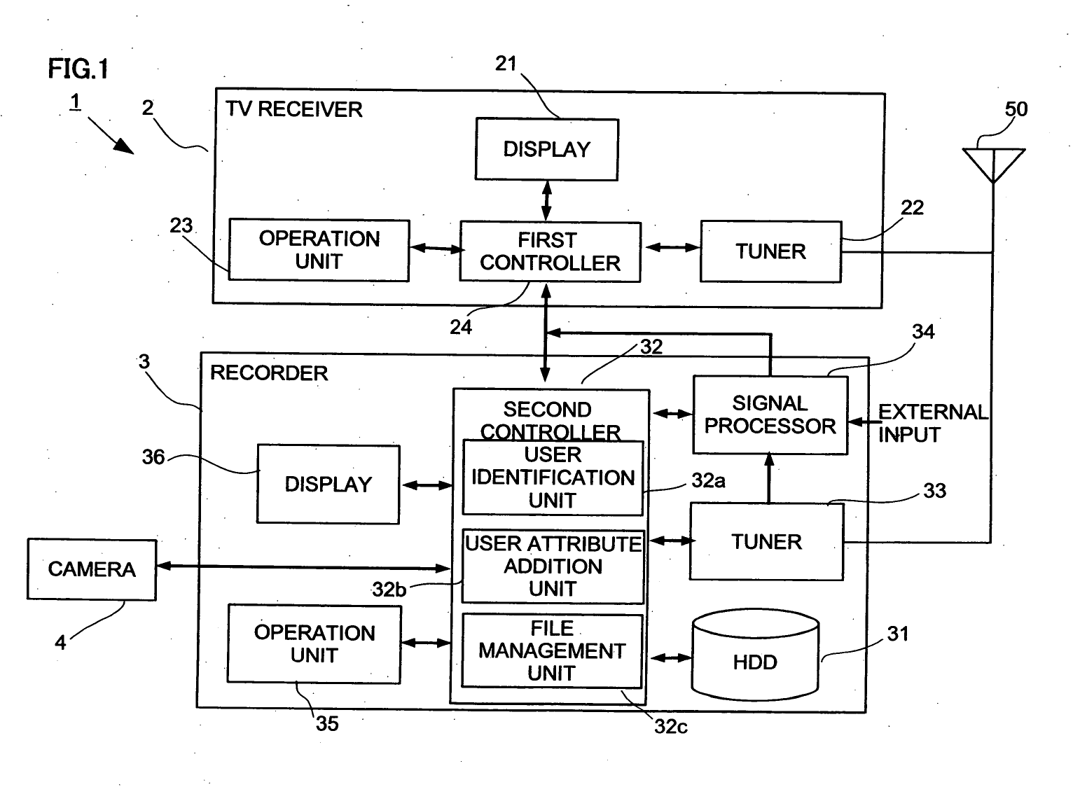

A preferred embodiment of the present invention is described below with reference to the drawings. FIG. 1 shows a block configuration of an example of a TV broadcast viewing and recording system according to the present preferred embodiment. The TV broadcast viewing and recording system 1 comprises a TV receiver 2, a recorder 3, and a camera (an image pickup device) 4 connected to the recorder 3. An external antenna 50 is connected to both the TV receiver 2 and the recorder 3. The TV receiver 2 and the recorder 3 are connected to each other to allow for a data communication, as described below.

The TV receiver 2 includes a display 21, a tuner 22 to which the antenna 50 is connected, an operation unit 23, and a first controller 24 which is connected to the display 21, the tuner 22 and the operation unit 23 and which is composed of a CPU, a memory, and so on. The display 21 is composed of a liquid crystal display panel or the like, for example, and displays images in viewable. The tuner 22 extracts signals of a desired channel from TV broadcast signals which are inputted from the antenna 50 and outputs the video signals and audio signals. The operation unit 23 is composed of, for example, channel selection buttons, a remote control transmitter, a receiver, and so on, and operated by a user to select a desired channel or to input various instructions. The TV receiver 2 displays images of a selected TV broadcast program on the display 21 with using video signals and audio signals directly extracted from the TV broadcast signals by the tuner 22 or reproduced by the recorder 3 as described below. At this time, the first controller 24 is adapted to display a predetermined message on the display 21 as described below.

The recorder 3 is a so-called hard disk recorder and comprises a hard disk drive (HDD) 31 inside. The recorder 3 has a recording function and a reproducing function. The recording function is performed so that video signals and audio signals of a selected channel are extracted from the TV broadcast signals inputted from the external antenna 50, and records the video signals and the audio signals as a data file of TV program in digital signals into the hard disc drive 31 corresponding to the operation by a user. The reproducing function is performed so that the video signals and the audio signals are reproduced from the data file of TV program which is read out from the hard disc drive 31 and transmits to the video signals and the audio signals to the TV receiver 2. In addition, the recorder 3 also has a time-shift function to reproduce a TV program from the beginning before completing the recording of the TV program while recording the TV program on the air at that time.

The recorder 3 includes the hard disc drive 31 described above, a second controller 32 which controls the whole recorder 3, a tuner 33 which extracts signals of a desired channel from TV broadcast signals, which are inputted from the external antenna 50, delivered from several TV stations and also which outputs the signals as video signals and audio signals, a signal processor 34 which converts the video signals, which are extracted by the tuner 33, or video signals, which are inputted from an external AV (Audio and Visual) apparatus and so on through an external input terminals (not shown) into digital signals and also which converts the digital signals into video signals and then transmits the video signals to the TV receiver 2, an operation unit 35 which is composed of operation buttons, a remote control transceiver, and a display 36 which is composed of a liquid crystal display device, an array of LED lamps, or the like and displays operation contents from the operation unit 35, operation mode of the recorder 3, a current time, and so on. The second controller 32 is composed of a CPU, a memory, and so on, and controls various functions such as a recording function, a reproduction function, and so on by controlling the respective portions in the recorder 3. The second controller 32 includes a user identifying unit 32a, a user attribute addition unit 32b, and a file management unit 32c as control programs to perform such a control as described above.

The camera 4 includes an image pickup device such as, for example, a CCD. (Charge Coupled Device), CMOS (Complementary Metal Oxide Semiconductor), and so on, and is disposed to take an image of a predetermined imaging area in front of the TV receiver 2 or the recorder 3. In other words, the camera 4 is disposed so as to take the image of the user who uses the TV receiver 2 and the recorder 3. The camera 4 is connected to the recorder 3 so that it can communicate with the second controller 32 in the recorder 3. The camera 4 takes the image of the predetermined area at predetermined time intervals, every 0.5 second, for example, and then transmits image data to the second controller 32. The camera 4 may be integrated with the recorder 3. Moreover, the camera 4 can also be connected to the TV receiver 2 to transmit the image data to the second controller 32 through the TV receiver 2.

Subsequently, in the TV broadcast viewing and recording system 1, an example of recording operation of the recorder 3 is described. The recorder 3 can perform a normal recording action to record programs immediately after operated by the user, and a so-called programmed recording action to record a preset channel program at a programmed time preset by the user.

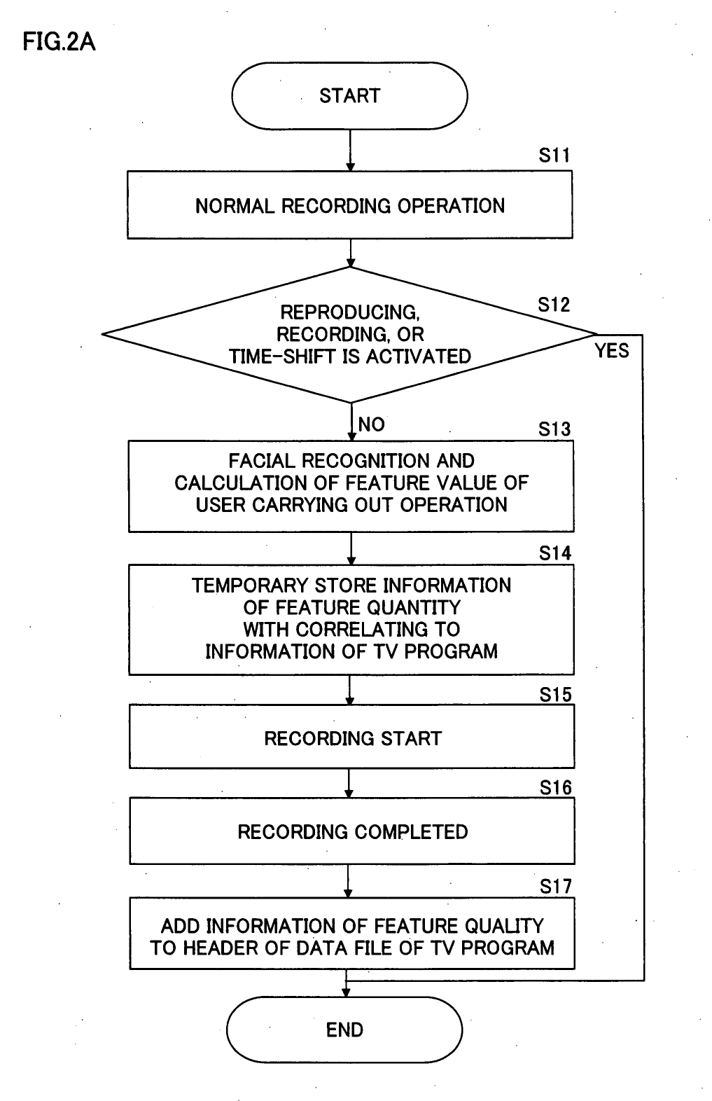

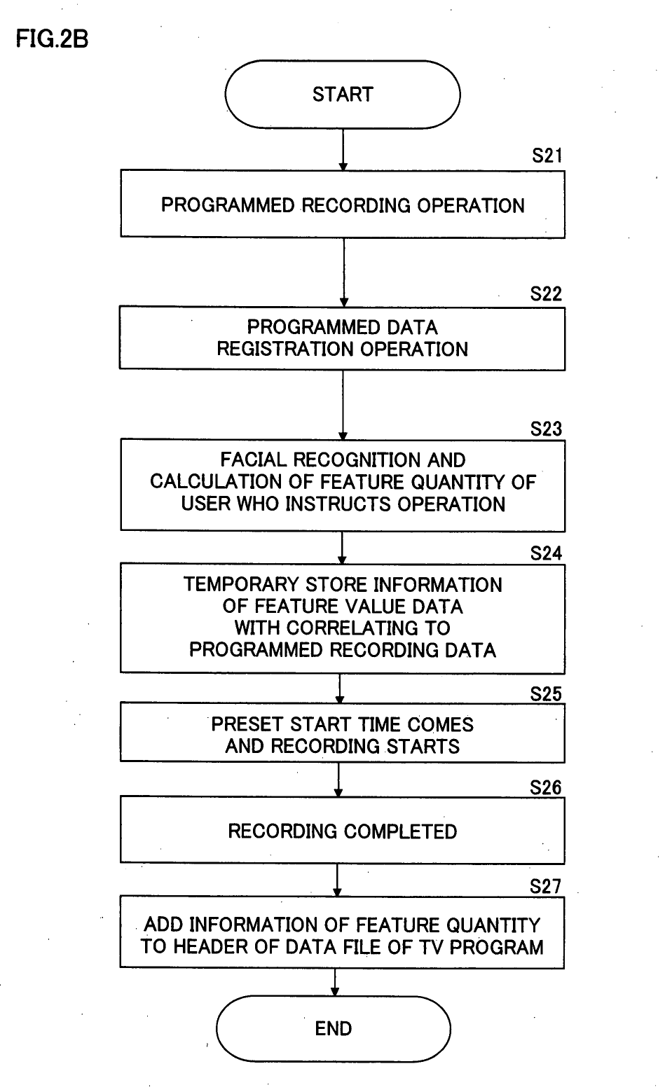

FIG. 2A is a flowchart showing an example of the normal recording operation, and FIG. 2B is a flowchart showing an example of the programmed recording operation. As shown in FIG. 2A, when the user instructs to perform a normal recording operation (S11), the second controller 32 judges whether a reproducing, a recording, or a time-shift is activated or not (S12). When any of them is activated, no TV program can be recorded, thus the normal recording operation is canceled. Alternatively, when none of them is activated and a TV program can be recorded, the user identification unit 32a carries out a facial recognition based on the image data taken by the camera 4 at that time (S13). The user identification unit 32a can identify the user who instructs to perform the recording operation by calculating a feature quantity of the user, whose image is taken, by the facial recognition. When the user identification unit 32a calculates the feature quantity of the user, the user attribute addition unit 32b temporarily stores information relating to that feature quantity of the user in the hard disc drive 31 with corresponding to information relating to the TV program to be recorded (S 14). Subsequently, when the recording starts (S15), the video signals and so on extracted by the tuner 33 are converted into digital signals in the signal processor 34, and subsequently, after compressively encoded, they are successively stored in the hard disc drive 31 as a temporary data file of TV program. When the user carries out an operation to finish the recording or when an ending time of the TV program specified by the user comes while the recording, the recording is completed (S 16). When the recording is completed, the user attribute addition unit 32b adds the information of the feature quantity, which is temporarily stored, to a header of the data file of TV program, and the data file of TV program is stored into the hard disc drive 31(S17). Consequently, a data attribute of the user who makes the data file of TV program can be added to the data file of TV program.

The programmed recording operation is substantially similar to the normal recording operation. As shown in FIG. 2B, a programmed recording operation is carried out (S21), and various programmed data registration operations such as presetting a start time, selection of a TV program to be recorded, selection of image quality of the TV program, and so on are carried out (S22). When the programmed data registration operation is carried out, the feature quantity of the user, who instructs the operations, is calculated by the user identification unit 32a (S23). The information of the feature quantity of the user is temporarily stored in the user attribute addition unit 32b with corresponding to the programmed recording data (S24). When the preset start time to start recording comes, the recording is started and continued until a stop time to stop the recording comes or the TV program to be recorded ends (S25). When the recording is completed and a temporary data file of TV program is formed (S26), the user attribute addition unit 32b adds the information of the feature quantity of the user to a header of the data file of TV program, and the data file of TV program is stored into the hard disc drive 31 (S27).

When the recording action is completed as described above, the file management unit 32c adds a record of the data file of TV program which is just recorded into a database that records reproduction history of each user who operates this TV broadcast viewing and recording system 1, so that the data of the reproduction history relating to the data files of TV programs are managed. In other words, in the reproducing operation of the recorded data file, the user who instructs the reproducing operation is automatically identified by the user identification unit 32a in the same manner as described above. Subsequently, the file management unit 32c updates the record of the reproduction history of the data file of the reproduced TV program for the identified user.

In the reproduction operation, the recorder 3 reads out the data file of TV program to be reproduced from the hard disc drive 31. Subsequently, the signal processor 34 decodes the data file of TV program, and converts the digital signals decoded from the data file into the video signals and audio signals. Then, the recorder 3 outputs the video signals and audio signals to the TV receiver 2 through output terminals (not shown). Consequently, images and sounds of the TV program are reproduced on the display 21 and from speakers (not shown) of the TV receiver 2 so that the user can view the TV program.

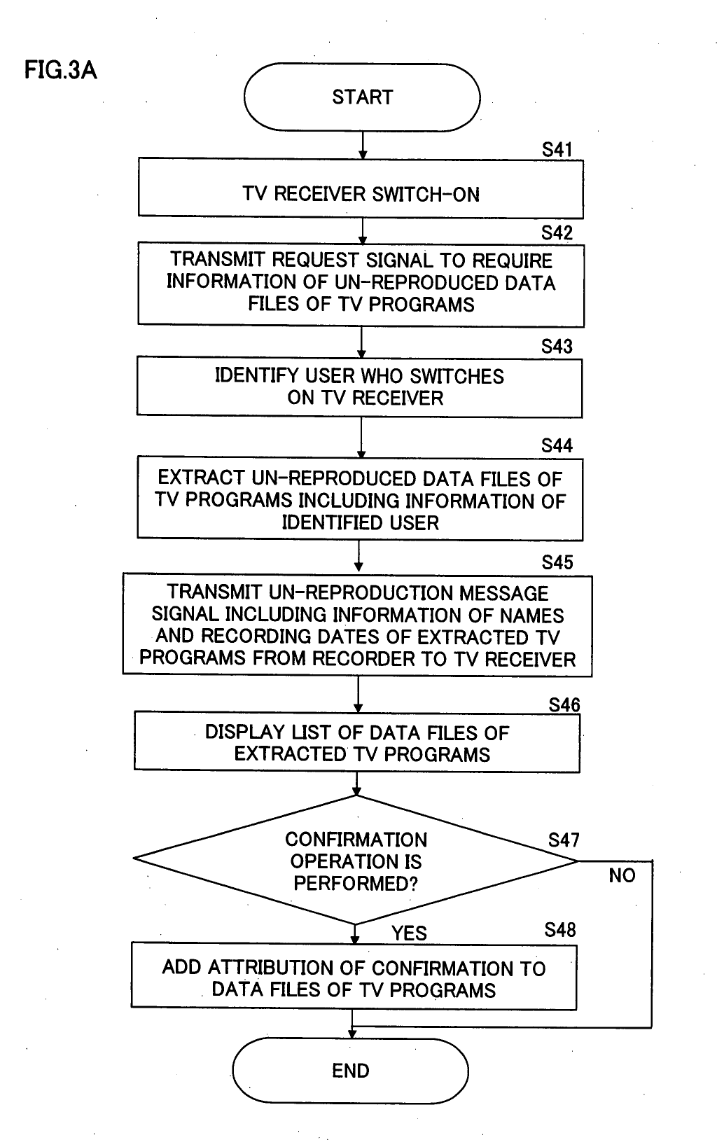

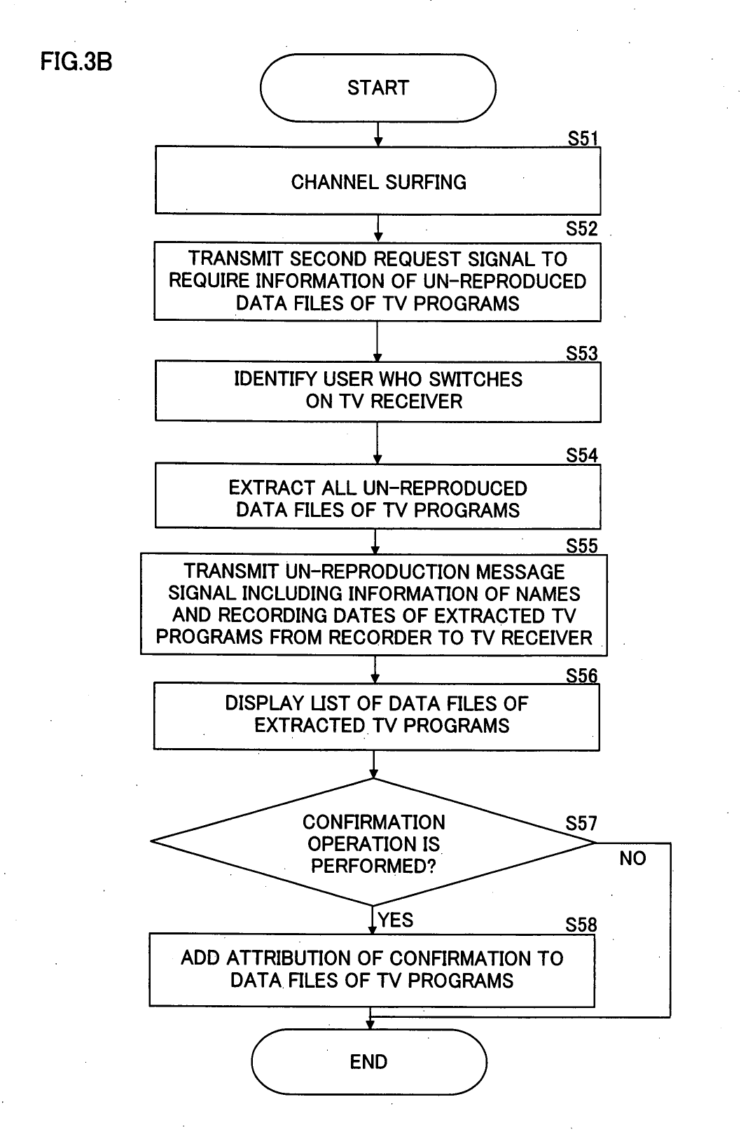

The TV broadcast viewing and recording system 1 notifies a user that a data file a TV program which has not been reproduced exists in the recorder 3 when the user instructs a predetermined operation to the TV receiver 2, so as to encourage the user to reproduce the TV program. Specifically, when the user switches on the electric power of the TV receiver 2 for enabling viewing of a TV program, or when the user changes the channels of the TV programs more than four times in fifteen seconds (channel surfing) for example, the TV broadcast viewing and recording system 1 performs the operation to encourage the user to reproduce the TV programs which are recorded in the hard disc drive 31 of the recorder 3 but have not been reproduced yet. At that time, when the electric power of the TV receiver 2 is switched on, the TV broadcast viewing and recording system 1 lists the TV programs which are recorded by the user but have not been reproduced yet, which are individually extracted from the database on the basis of the information of the identified user. Alternatively, when the user surfs the channels, the TV broadcast viewing and recording system 1 lists all the TV programs which have not been reproduced yet with no relation to the identification of the user. In other words, the TV broadcast viewing and recording system 1 encourages the user to reproduce the TV programs which are recorded by the same user in priority to the TV programs which are recorded by other users. FIGS. 3A and 3B show examples of those operations.

FIG. 3A shows the operation to encourage the user to reproduce data files of TV programs which are not reproduced yet when electric power of the TV receiver 2 is switched on.

When the user switches on the electric power of the TV receiver 2 (S41), the first controller 24 of the TV receiver 2 transmits a first request signal that requires of the recorder 3 to transmit individual information of the un-reproduced TV programs for the user who switches on the TV receiver 2 (S42). When the second controller 32 of the recorder 3 receives the first request signal, the user identification unit 32a of the recorder 3 identifies the user who switches on the TV receiver 2 by calculating the feature value of the user on the basis of the image data taken by the camera 4 (S43). Subsequently, the file management unit 32c extracts one or more data files of TV programs which include information conforming to the feature quantity of the identified user and which have not been reproduced yet by the user from the database (S44). At that time, the data files of TV programs having attribution that un-reproduction are confirmed by the user are not extracted even though the data files of TV programs have not been reproduced yet.

Subsequently, the second controller 32 forms an un-reproduction message signal including information of names, recording dates of extracted TV programs, and transmits the un-reproduced message signal to the TV receiver 2 (S45). When the TV receiver 2 receives the un-reproduced message signal, the TV receiver 2 displays the information relating to the extracted data files of TV programs on the basis of the un-reproduced message signal on the display 21, so that the user can confirm the data files of TV programs not reproduced yet (S46). In other words, the user can confirm the fact that the data files of TV programs which were recorded by the user but have not been reproduced yet exist in the recorder 3 by viewing the information displayed on the display 21 of the TV receiver 2. At this time, the information of the data files of TV programs is displayed on the display 21 of the TV receiver 2 as a list. Alternatively, the information of each data file of TV program may be overlaid on the moving picture of the TV program displayed on the display 21 of the TV receiver 2. Alternatively, it is possible to switch between the list of the information of the data files of TV programs and the overlay of the information on the moving picture of the TV program.

Subsequently, when the user performs confirmation operation to confirm that the listed data files of TV programs have not been reproduced yet by operating the operation unit 23 or 35 (YES in S47), the file management unit 32c of the recorder 3 adds the above mentioned attribution that un-reproduction are confirmed by the user to the headers of the data files of TV programs stored in the database on the hard disc drive 31 of the recorder 3 (S48). By adding the attribution to the data files of TV programs which are already listed on the display 21 of the TV receiver 2 as the confirmed data files, the data files of TV programs which are listed and displayed on the display 21 of the TV receiver 2 once are excluded from the list of the data files of TV programs which have not been reproduced yet when the user switches on the TV receiver 2 again or surfs the channels. Thus, the same information relating to the data files of TV programs which have not been reproduced yet is not displayed on the display 21 of the TV receiver 2, repeatedly, so that the user never feels botheration.

FIG. 3B shows the operation to encourage the user to reproduce data files of TV programs which are not reproduced yet when the user frequently switches the channels.

When the first controller 24 detects the channel surfing where the users frequently changes the channels (S51), the first controller 24 of the TV receiver 2 transmits a second request signal that requires of the recorder 3 to transmit information of all the un-reproduced TV programs which are recorded in the recorder 3 but have not been reproduced yet so as to notify the user of all the un-reproduced data files of TV programs (S52). When the second controller 32 of the recorder 3 receives the second request signal, the user identification unit 32a of the recorder 3 identifies the user who switches the channels of the TV receiver 2 by calculating the feature value of the user on the basis of the image data taken by the camera 4 (S53). Subsequently, the file management unit 32c extracts one or more data files of TV programs which have not been reproduced yet by the user and which are not confirmed by the user from database (S54). At that time, the data files of TV programs which are extracted from the database are not limited to those having the attribution of the identified user, so that all data files of TV programs which have not been reproduced are extracted.

Subsequently, the second controller 32 forms an un-reproduction message signal including information relating to the extracted data files of TV programs, and transmits the un-reproduced message signal to the TV receiver 2 (S55). When the TV receiver 2 receives the un-reproduced message signal, the TV receiver 2 displays the information relating to the extracted data files of TV programs on the basis of the un-reproduced message signal on the display 21, so that the user can confirm the data files of TV programs not reproduced yet (S56). At that time, the information of the un-reproduced data files of TV programs which were recorded through the operation by the user is displayed in priority to the information of the un-reproduced data files of TV programs recorded by other users by displaying them at the top of the list, for example. Consequently, the user can steadily confirm the information of un-reproduced data files of TV programs relating furthermore to the user.

Subsequently, when the user performs confirmation operation to confirm that the listed data files of TV programs have not been reproduced yet by operating the operation unit 23 or 35 (YES in S57), the file management unit 32c of the recorder 3 adds the above mentioned attribution that un-reproduction are confirmed by the user to the headers of the data files of TV programs stored in the database on the hard disc drive 31 of the recorder 3 (S58).

As described above, according to the TV broadcast viewing and recording system of this embodiment, the information relating to the data files of TV programs which have not been reproduced yet by the user who operates the TV receiver 2 are displayed automatically on the display 21 of the TV receiver 2. Thus, the user can become aware of the TV programs which have not been viewed yet by the user, so that the viewing efficiency for the user to view the recorded TV programs can be further enhanced. At that time, the data files of TV programs which include information conforming to the feature quantity of the user are extracted preferentially, so that it is possible to obtain steadily the data relating to the data files of TV programs which are recorded through the operation of the user. Consequently, the user can further become aware of the un-reproduced data files of TV programs relating to the user, and thereby, the TV broadcast viewing and recording system 1 becomes more convenient.

Furthermore, the identification of the user is carried out automatically with the facial recognition of the image data taken by the camera 4, so that the TV broadcast viewing and recording system 1 can be used easily and conveniently without troublesome manual switching operation for identifying the user manually even when using the TV broadcast viewing and recording system 1 with the several users. Still furthermore, the request signal is transmitted when the user switches on the TV receiver 2 or surfs the channels, so that the information of un-reproduced data files of TV programs is displayed on the display 21 of the TV receiver 2 in a time when the user may not view a TV program. Consequently, the viewing efficiency for the user to view the un-reproduced data files of TV programs can be enhanced by encouraging the user to view them timely without interrupting the user's viewing the TV programs.

The present invention is not limited to the configuration of the embodiment described above. It, however, is possible to apply various modifications without departing from the scope of the present invention. For example, the recorder 3 is not limited to the so-called hard disk player, however, an apparatus, which can record and reproduce programs by creating recorded files in other recording media such as a DVD, for example, is also applicable. Furthermore, the timing of the TV receiver 2 transmitting the request signal to the recorder 3 is not limited to the timing described above, however, the request signal can also be transmitted at various times, for example, any time the user pushes a predetermined operation button or enters a command, a predetermined time after the user carries out an operation, and so on. Still furthermore, when there are the un-reproduced data files of TV programs which are recorded by the user, who is identified by the facial recognition, in the recorder 3, it is also applicable to make the TV receiver 2 display simply a message to notify the user of the un-reproduced data files of TV programs, instead of displaying the information of the data files of TV programs as described above. In other words, the viewing efficiency for each user to view the un-reproduced data files the TV programs can be enhanced more conveniently by transmitting the request signal from the TV receiver 2, identifying the user on the basis of the image data taken by the camera 4 through the facial recognition in the recorder 3, and then making the TV receiver 2 display the information of the un-reproduced data files of TV programs for the identified user, even when the TV broadcast viewing and recording system is used by the several users.

In summary, the TV broadcast viewing and recording system in accordance with the present invention comprises: a TV receiver which receives TV broadcast signals and displays a TV program of a channel specified by an operation of a user so that the user can view the TV program; a recorder which is connected to the TV receiver and which has a recording function to receive TV broadcast signals and to store a data file of TV program in response to an operations of a user and a reproduction function to reproduce the recorded data file of TV program as video signals and audio signals and then transmits the reproduced video signals and audio signals to the TV receiver so that a user can view a recorded TV program; and an image pickup device which is provided to communicate with the recorder or the TV receiver and takes an image in a predetermined area in front of the TV receiver. The TV receiver and the recorder are connected to each other to enable data communication. The recorder manages a reproduction history of data files of TV programs for each user by performing facial recognition based on an image data taken by the image pickup device, and identifies a user by calculating a feature quantity of the user based on the image data taken by the image pickup device. When the TV receiver is operated a predetermined operation by a user, the TV receiver transmits a predetermined request signal to the recorder in response to the operation by the user. When the recorder receives the request signal, the recorder identifies the user who operates the TV receiver by performing facial recognition based on an image data taken by the image pickup device, and the recorder transmits a predetermined massage signal showing existence of un-reproduced one or more data files of TV programs which are recorded by the identified user in case that the un-reproduced data files of TV programs exist. The TV receiver displays information relating to the un-reproduced data files of TV programs based on the message signal on a display thereof.

It is preferable that the recorder identifies a user who instructs to perform a recording operation of a TV program and stores a data of a feature quantity of the user with corresponding to a recorded data file of TV program. When the recorder receives the request signal from the TV receiver, the recorder may transmit the message signal which includes information relating to data files of TV programs each having the feature quantity conforming to the feature quantity of the identified user, in priority to information relating to other data files of TV programs which have not been reproduced yet; and the TV receiver may display a list of the un-reproduced data files of TV programs based on the information relating to data files of TV programs included in the message signal on the display.

When the list of the un-reproduced data files of TV programs is displayed on the display of the TV receiver, the user can perform a predetermined confirmation operation, and the TV receiver transmits a confirmation signal to the recorder. When the recorder receives the confirmation signal, the recorder may add an attribution of confirmation that un-reproduction are confirmed by the user to each of the data files of TV programs which are listed in the list as the un-reproduced data files of TV programs, and the recorder may not extract the data files of TV programs having the attribution of confirmation even though the data files of TV programs have not been reproduced yet.

Furthermore, the TV receiver may transmit different request signal to the recorder corresponding to the operation by the user, and the recorder may transmit different message signal corresponding to the request signal from the TV receiver.

The recorder may identify a user who instructs to perform a recording operation of a TV program and stores a data of a feature quantity of the user with corresponding to a recorded data file of TV program. When the recorder receives the request signal from the TV receiver, the recorder may transmit the message signal which includes information relating to data files of TV programs each having the feature quantity conforming to the feature quantity of the identified user, in priority to information relating to other data files of TV programs which have not been reproduced yet, and the TV receiver may display a list of the un-reproduced data files of TV programs based on the information relating to data files of TV programs included in the message signal on the display.

When the operation by the user enables to view a TV program on a display of the TV receiver, the TV receiver may transmit a first request signal, and when the user changes channels of the TV receiver more than a predetermined number in a predetermined time period, the TV receiver may transmit a second request signal. When the recorder receives the first request signal, the recorder may extract only the data files of TV programs which are recorded by the identified user but have not been reproduced yet from a database recorded in the recorder, and transmits the extracted data files of TV programs with the message signal, and when the recorder receives the second request signal, the recorder may extract all data files of TV programs which have not been reproduced yet with no relation to the identified user, and transmits the extracted data files of TV programs with the message signal.

In case that the TV receiver transmits the second request signal to the recorder, the TV receiver may display the list of the un-reproduced data files of TV programs so that the data files of TV programs each having the feature quantity conforming to the feature quantity of the identified user are displayed at upper portion of the list.

When, the list of the un-reproduced data files of TV programs is displayed on the display of the TV receiver, the user can perform a predetermined confirmation operation, and the TV receiver transmits a confirmation signal to the recorder. When the recorder receives the confirmation signal, the recorder may add an attribution of confirmation that un-reproduction are confirmed by the user to each of the data files of TV programs which are listed in the list as the un-reproduced data files of TV programs, and the recorder may not extract the data files of TV programs having the attribution of confirmation even though the data files of TV programs have not been reproduced yet.

This application is based on Japanese patent application 2006-29829 filed Feb. 7, 2006 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. A television (TV) broadcast viewing and recording system comprising:
a TV receiver which receives TV broadcast signals and displays a TV program of a channel specified by an operation of a user so that the user can view the TV program;
a recorder which is connected to the TV receiver and which has a recording function to receive TV broadcast signals and to store a data file of TV program in response to an operations of a user and a reproduction function to reproduce the recorded data file of TV program as video signals and audio signals and then transmits the reproduced video signals and audio signals to the TV receiver so that a user can view a recorded TV program; and
an image pickup device which is provided to communicate with the recorder or the TV receiver and takes an image in a predetermined area in front of the TV receiver, wherein
the TV receiver and the recorder are connected to each other to enable data communication;
the recorder manages a reproduction history of data files of TV programs for each user by performing facial recognition based on an image data taken by the image pickup device, and identifies a user by calculating a feature quantity of the user based on the image data taken by the image pickup device;
when the TV receiver is operated a predetermined operation by a user, the TV receiver transmits a predetermined request signal to the recorder in response to the operation by the user;
when the recorder receives the request signal, the recorder identifies the user who operates the TV receiver by performing facial recognition based on an image data taken by the image pickup device, and the recorder transmits a predetermined massage signal showing existence of un-reproduced one or more data files of TV programs which are recorded by the identified user in case that the un-reproduced data files of TV programs exist; and
the TV receiver displays information relating to the un-reproduced data files of TV programs based on the message signal on a display thereof.

2. The TV broadcast viewing and recording system in accordance with claim 1, wherein
the recorder identifies a user who instructs to perform a recording operation of a TV program and stores a data of a feature quantity of the user with corresponding to a recorded data file of TV program; and
when the recorder receives the request signal from the TV receiver, the recorder transmits the message signal which includes information relating to data files of TV programs each having the feature quantity conforming to the feature quantity of the identified user, in priority to information relating to other data files of TV programs which have not been reproduced yet; and
the TV receiver displays a list of the un-reproduced data files of TV programs based on the information relating to data files of TV programs included in the message signal on the display.

3. The TV broadcast viewing and recording system in accordance with claim 2, wherein
when the list of the un-reproduced data files of TV programs is displayed on the display of the TV receiver, the user can perform a predetermined confirmation operation, and the TV receiver transmits a confirmation signal to the recorder;
when the recorder receives the confirmation signal, the recorder adds an attribution of confirmation that un-reproduction are confirmed by the user to each of the data files of TV programs which are listed in the list as the un-reproduced data files of TV programs; and
the recorder does not extract the data files of TV programs having the attribution of confirmation even though the data files of TV programs have not been reproduced yet.

4. The TV broadcast viewing and recording system in accordance with claim 1, wherein
the TV receiver transmits different request signal to the recorder corresponding to the operation by the user; and
the recorder transmits different message signal corresponding to the request signal from the TV receiver.

5. The TV broadcast viewing and recording system in accordance with claim 4, wherein
the recorder identifies a user who instructs to perform a recording operation of a TV program and stores a data of a feature quantity of the user with corresponding to a recorded data file of TV program; and
when the recorder receives the request signal from the TV receiver, the recorder transmits the message signal which includes information relating to data files of TV programs each having the feature quantity conforming to the feature quantity of the identified user, in priority to information relating to other data files of TV programs which have not been reproduced yet; and
the TV receiver displays a list of the un-reproduced data files of TV programs based on the information relating to data files of TV programs included in the message signal on the display.

6. The TV broadcast viewing and recording system in accordance with claim 5, wherein
when the operation by the user enables to view a TV program on a display of the TV receiver, the TV receiver transmits a first request signal;
when the user changes channels of the TV receiver more than a predetermined number in a predetermined time period, the TV receiver transmits a second request signal;
when the recorder receives the first request signal, the recorder extracts only the data files of TV programs which are recorded by the identified user but have not been reproduced yet from a database recorded in the recorder, and transmits the extracted data files of TV programs with the message signal; and
when the recorder receives the second request signal, the recorder extracts all data files of TV programs which have not been reproduced yet with no relation to the identified user, and transmits the extracted data files of TV programs with the message signal.

7. The TV broadcast viewing and recording system in accordance with claim 6, wherein
in case that the TV receiver transmits the second request signal to the recorder, the TV receiver displays the list of the un-reproduced data files of TV programs so that the data files of TV programs each having the feature quantity conforming to the feature quantity of the identified user are displayed at upper portion of the list.

8. The TV broadcast viewing and recording system in accordance with claim 6, wherein
when the list of the un-reproduced data files of TV programs is displayed on the display of the TV receiver, the user can perform a predetermined confirmation operation, and the TV receiver transmits a confirmation signal to the recorder;
when the recorder receives the confirmation signal, the recorder adds an attribution of confirmation that un-reproduction are confirmed by the user to each of the data files of TV programs which are listed in the list as the un-reproduced data files of TV programs; and
the recorder does not extract the data files of TV programs having the attribution of confirmation even though the data files of TV programs have not been reproduced yet.

9. A recorder which is connectable to an external TV receiver so as to enable data communication therebetween and has a recording function to receive TV broadcast signals and to store a data file of TV program in response to an operation of a user and a reproduction function to reproduce a data file of TV program as video signals and audio signals and then transmits the reproduced video signals and audio signals to the external TV receiver so that a user can view a recorded TV program through the TV receiver, comprising:
an image pickup means which takes an image in a predetermined area in front of the recorder;
a user identification means which identifies a user who stays in the imaging area by performing facial recognition and calculating a feature quantity of the user based on an image data taken by the image pickup means;
a file management means which manages a reproduction history of data files of TV programs for each identified user, and transmits information of data files of TV programs which has not been reproduced yet when a predetermined request signal is transmitted from the external TV receiver in response to an operation by the user.

10. The recorder in accordance with claim 9, wherein
the file management means extracts the data files of TV programs each having an attribution conforming to an attribution of the identified user among all recorded data files of TV programs as the information of data files of TV programs.

11. A TV receiver which receives TV broadcast signals and displays a TV program of a channel specified by a user, and also can display a TV program recorded and reproduced through an external recorder when connected to the external recorder, wherein
the TV receiver and the recorder are connected to each other to allow for a data communication;
when the TV receiver detects a predetermined operation by a user, the TV receiver can transmit predetermined request signals to the recorder; and
when the TV receiver receives a predetermined un-reproduced message signal including information of data files of TV programs which has not been reproduced yet, the TV receiver displays a list of which has not been reproduced yet on a display thereof.

12. The TV receiver in accordance with claim 11, wherein
the TV receiver transmits different request signal corresponding to kind of operation by the user.
